(19) United States
(12) Patent Application Publication
(10) Pub. No.: US 2015/0290797 A1
(43) Pub. Date: Oct. 15, 2015

(54) Smasher Bot

(71) Applicants: Dale Randolph, Haverhill, MA (US); Chris Meehan, Haverhill, MA (US)

(72) Inventors: Dale Randolph, Haverhill, MA (US); Chris Meehan, Haverhill, MA (US)

(21) Appl. No.: 14/252,401

(22) Filed: Apr. 14, 2014

(51) Int. Cl. B25J 9/16; B25J 11/00; B25J 9/08

(52) U.S. Cl. CPC B25J 9/161; B25J 9/08; B25J 11/005

(57) ABSTRACT

This is a simple robot device which will grip, maneuver (via wired or remote control), and utilize off the commonly manufactured tools under the direct control of a human. The human will be free from the physical damages and strains caused by the use of these commonly manufactured tools.

### BACKGROUND

During the use of various construction and demolition tools the tool operator is exposed to various fatiguing vibrations and body strains. These rapidly take a toll on the operator and over a brief period the operator tires, becomes sore, and production wanes. Continued use can cause long term damage to the human body.

### SUMMARY

This invention is intended to provide an attended robot to grip and use existing tools (commercially available, off the shelf equipment) in order to relieve the stress and strain on the operator. The robot holds and utilizes the tool, thereby isolating the operator. The operator is connected to the robot by wire or wireless connection, and observes, views, and directs all of the robots actions. The robot is intended to be light enough to be readily transported by 2 laborers, up and down stairs etc. Connections are intended to be “breakaway” allowing the robot to sustain damage without damage to the controller and power pack.

### DESCRIPTION AND DRAWINGS

Drawing Page 1 of 3 provides a side and top view of the various main components of the “Smasher” robot. The components are as follows:

FIG. 1. Commercially available Hammer—a commercially available tool, hammer, hammer drill, etc.

FIG. 2. Adaptor—Adaptor or grip that holds the tool in a secure fashion and makes its use possible.

FIG. 3. Casters—wheels to permit steering of the robot.

FIG. 4. Joint—This joint allows adjustment of the “angle of attack” of the tool, allowing the operator to angle the tool to the optimum angle for the task at hand.

FIG. 5. Adjustable Arm—The arm leading to the joint and grip is adjustable to permit tools of differing lengths and configurations to be used by the robot and operator.

FIG. 6. Motor & Transmission—The motor(s) drive all adjustments and the carriage of the robot and the drive wheels.

FIG. 7. Drive Wheels—Driven by the Motor and Transmission the drive wheels move as needed to position the robot for work. (Tracks may also be utilized instead of the caster and wheel configuration).

FIG. 8. Control and Power Wires—These connect the robot back to the remote controller unit. Drawing page 2 of 3 provides a front and side view of the remote mounted controls and power supply.

FIG. 8. Control and Power Wires—These connect the remote controller unit to the robot.

FIG. 9. “Game” controller—provides the operator with complete control of the unit, on/off, drive, steerage, adjustments, etc.

FIG. 10. Computer and supporting electronics—This box contains the computer module and all supporting components for the robot device.

FIG. 11. Battery—The battery provides power to the controller and computer device and drive motor of the robot. Various batteries and types of batteries may be used.

FIG. 12. Two Wheeler—The two wheeler is used to provide easy transportation of the robot control devices and power supply. Drawing page 3 of 3 contains numerical label names of the parts 1-12 of pages 2 and 3 of the drawings.

### DETAILED DESCRIPTION

The robot is manufactured using standard tools and metals to construct a rugged frame. Drive wheels (FIG. 7) and motor and transmission (FIG. 6) are mounted onto the frame by bolting. The drive wheels (FIG. 7) are exposed, but the motor and transmission (FIG. 6) in a protected ventilated box to help reduce damage from debris.

The arm (FIG. 5) is again metal or other sturdy material, and is mounted on a pivot to the frame. The arm (FIG. 5) has an adjustable joint (FIG. 4) about 12 inches from the adapter (FIG. 2) grip allowing the angle of attack to be adjusted to permit optimum production.

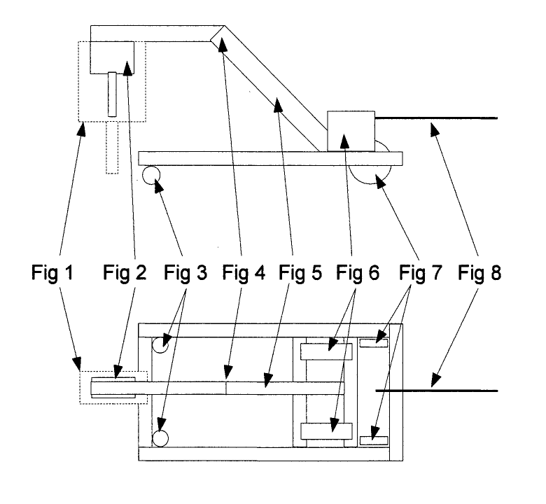

The adapter (FIG. 2) is a simple device attaching the commercially available hammer (FIG. 1) to the arm (FIG. 5). Several styles will be available to adapt to various manufacturer's designs. A general grip will be standard that will mimic the grip of a human hand. This is attached to the arm by bolts.

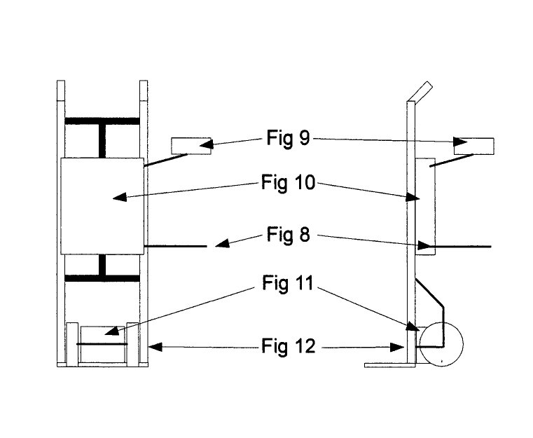

Controls and power wires (FIG. 8) to the game controller (FIG. 9) will be sized as needed to carry required voltage and amperage for operation.

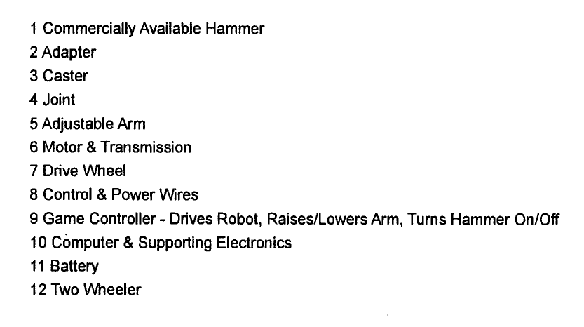

The computer and supporting electronics (FIG. 10) will be mounted in a ventilated box and bolted or welded to a two wheeler (FIG. 12) type carriage.

The battery (FIG. 11) will sit on the bottom of the two wheeler (FIG. 12), held into place through a clamping system. Connectors will be protected to prevent accidental contact.

Caster (FIG. 3) wheels permit the device to pivot within the radius of the body.

1. This robot device will protect the operator of certain tools from damage due to vibration and impact.
a. This is done by removing the tool from the operator's hand thereby isolating the operator entirely.

2. This robot device will protect the operator of certain tools from fatigue from operation of the tool, permitting an overall increase in production.
a. This is done by removing the tool from the operator's hand thereby isolating the operator from the fatigue of movement of the tool.

3. This robot device will increase operator safety.
a. This is done by removing the operator from the tool, isolating the operator from slips, trips, and falls while utilizing the tool. The operator is a safe distance away observing and directing the tool. In the event of a collapse the operator should be reasonably safe.

4. This robot device is small, lightweight, and readily transported in a pick up or van and maneuvered to a floor of a structure by being hand carried.

5. This robot device will run on single phase power permitting its use in virtually any area.

6. This robot device will be readily repairable, as major components will be able to be replaced by the operator.
